(19) United States
(12) Patent Application Publication
(10) Pub. No.: US 2026/0233951 A1
(43) Pub. Date: Aug. 13, 2026

(54) Liner for Material Handling System And Method

(71) Applicant: Crown Plastics Co., Harrison, OH (US)

(72) Inventor: Peter Ellerhorst, Harrison, OH (US)

(21) Appl. No.: 19/531,784

(22) Filed: Feb. 6, 2026

Related U.S. Application Data
(60) Provisional application No. 63/755,813, filed on Feb. 7, 2025.

(51) Int. Cl. B65G 47/96

(52) U.S. Cl. CPC B65G 47/962; B65G 2207/48

(57) ABSTRACT

A liner for a tilt tray of a conveyor assembly on a material handling system, where the tilt tray as a carrier plate with a perimeter defining a shape of the carrier plate is disclosed. The liner includes a support panel with a perimeter defining a shape of the support panel, wherein the shape of the support panel is configured to substantially correspond to the shape of the carrier plate of the tilt tray. The support panel includes a top surface and a bottom surface and an array of raised portions extending from the top surface. The support panel is made of a material that is resistant to static friction. A tilt tray assembly employing a liner with a support panel made of a material resistant to static friction is also disclosed. A method of transporting a package using that tilt tray assembly is also disclosed.

### CROSS REFERENCE TO RELATED APPLICATIONS

This application claims the benefit of U.S. Provisional Patent Application No. 63/755,813, filed on Feb. 7, 2025, the disclosure of which is incorporated by reference herein in its entirety.

### TECHNICAL FIELD

The present disclosure relates generally to material handling systems and, more particularly, low-friction liners for chutes, slides, and trays of such systems.

### BACKGROUND

Material handling systems are often used to transport individual packages from one location to another location in a distribution, fulfillment, or sorting center. For example, an incoming truck may bring in a large number of individual packages into a local sorting center. Each package may include some sort of identifier such as a bar code, QR code, or RFID tag that may be read by the material handling system to direct the package to a particular zone in the sorting center so that the package may be loaded onto an outgoing delivery truck.

When unloaded from the incoming truck, the packages may be loaded into a tilt tray sorting system. As the packages move through the sorting center, the system reads the identifier on the package and at the appropriate time and location, the tilt tray tilts upward so as to dump the package out of the tilt tray and onto a conveyor or chute that ultimately transports the package to the zone corresponding to the final destination of the package.

Often, the package may be a poly bag filled with a relatively lightweight product. As a result, there may be too much static friction between the poly bag and the metallic, flat bottom of the tilt tray for the ploy bag to slide out of the tilt tray under the influence of gravity when the tilt tray is commanded to tilt up and dump the package. In the end, the poly bag may not be directed to the correct zone and, therefore, may be delivered to the wrong destination.

What is needed is a tilt tray system that allows even lightweight poly bags to slide out of the tilt tray when it is tilted upwardly.

### SUMMARY

To these and other ends, a liner for a tilt tray of a conveyor assembly on a material handling system is disclosed. The tilt tray as a carrier plate with a perimeter defining a planform shape of the carrier plate. The liner includes a support panel with a perimeter defining a planform shape of the support panel. The planform shape of the support panel is configured to substantially correspond to the planform shape of the carrier plate of the tilt tray. The support panel has a top surface and a bottom surface and an array of raised portions extending from the top surface. The support panel is made of a material that is resistant to static friction. For example, the support panel may be made of a silicone-infused, ultra-high molecular weight (UHMW) material.

In one aspect, the array of the raised portions may extend across more than half of the top surface of the support panel.

In one aspect, the support panel may include a first edge portion configured to extend over a first edge of the carrier plate. The first edge portion may be configured to angle downwardly over the first edge of the carrier plate. The support panel may also include a second edge portion configured to extend over second edge of the carrier plate.

In another embodiment, a tilt tray assembly for use on a conveyor assembly on a material handling system is disclosed. The tilt tray assembly includes providing a tilt tray having a carrier plate with a perimeter defining a planform shape of the carrier plate. The tilt tray assembly also includes a liner having a support panel with a perimeter defining a planform shape of the panel. The planform shape of the support panel is configured to substantially correspond to the planform shape of the carrier plate of the tilt tray. The support panel has a top surface and a bottom surface and an array of raised portions extending from the top surface. The bottom surface of the support panel being secured to the carrier plate of the tilt tray. The support panel is made of a material that is resistant to static friction.

In one aspect, the support panel may be made of a silicone-infused, ultra-high molecular weight (UHMW) material.

In one aspect, the array of the raised portions may extend across more than half of the top surface of the support panel.

In one aspect, the support panel may include a first edge portion configured to extend over a first edge of the carrier plate. The first edge portion may be configured to angle downwardly over the first edge of the carrier plate. The support panel may also include a second edge portion configured to extend over a second edge of the carrier plate.

In one aspect, the support panel may be secured to the carrier plate of the tilt tray. In that regard, the support panel may be secured to the carrier plate of the tilt tray with an adhesive.

In one aspect, the tilt tray may include at least one sidewall extending from an edge of the carrier plate and an edge of the support panel of the liner is positioned adjacent to the at least one sidewall.

In another embodiment, a method of moving a package to a designated location on a conveyor assembly on a material handling system is disclosed. The method includes providing a tilt tray assembly on the conveyor assembly. The tilt tray assembly has a tilt tray with a carrier plate and a liner secured to the carrier plate. The liner has a support panel with an array of raised portions extending from a top surface of the support panel. The support panel being made from a material that is resistant to static friction. The method further includes placing the package on the liner, moving the tilt tray assembly to the designated location, and tilting the tilt tray sufficiently so that the package slides off the liner.

In one aspect, the support panel may be made of a silicone-infused, ultra-high molecular weight (UHMW) material.

In one aspect, the array of the raised portions may extend across more than half of the top surface of the support panel.

In one aspect, the support panel may be secured to the carrier plate of the tilt tray with an adhesive.

In one aspect, the tilt tray may include at least one sidewall extending from an edge of the carrier plate and an edge of the support panel of the liner is positioned adjacent to the at least one sidewall.

### BRIEF DESCRIPTION OF THE DRAWINGS

The accompanying drawings, which are incorporated in and constitute a part of this specification, illustrate one or more embodiments of the present disclosure and, together with a general description given above, and the detailed description given below, serve to explain the one or more embodiments of the present disclosure.

FIG. 1 is a schematic representation of a material handling system having a conveyor system with a liner according to an embodiment of the disclosure.

FIG. 2 is a perspective view of a representative tilt tray and liner according to an embodiment of the disclosure.

FIG. 3 is a plan view of the liner of FIG. 2 positioned on the tilt tray of FIG. 2.

FIG. 4 is a cross-sectional view of the tilt tray and liner of FIG. 3 with a package positioned on the liner.

### DETAILED DESCRIPTION

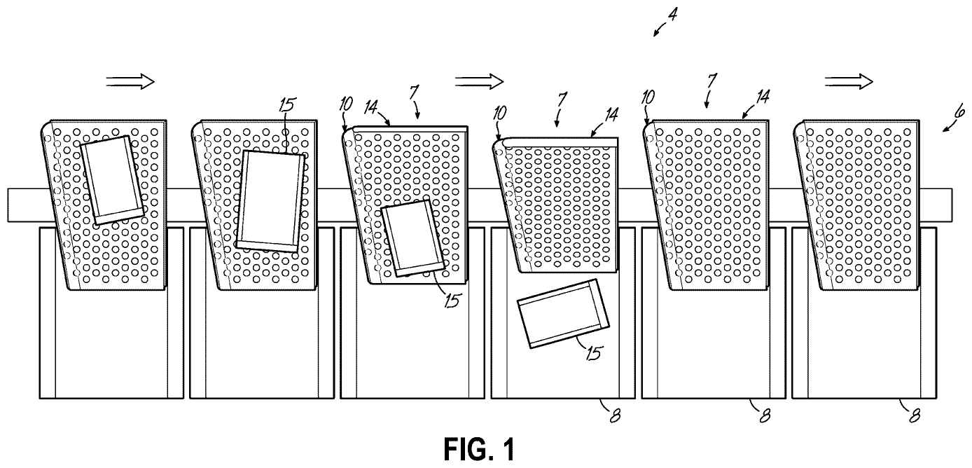

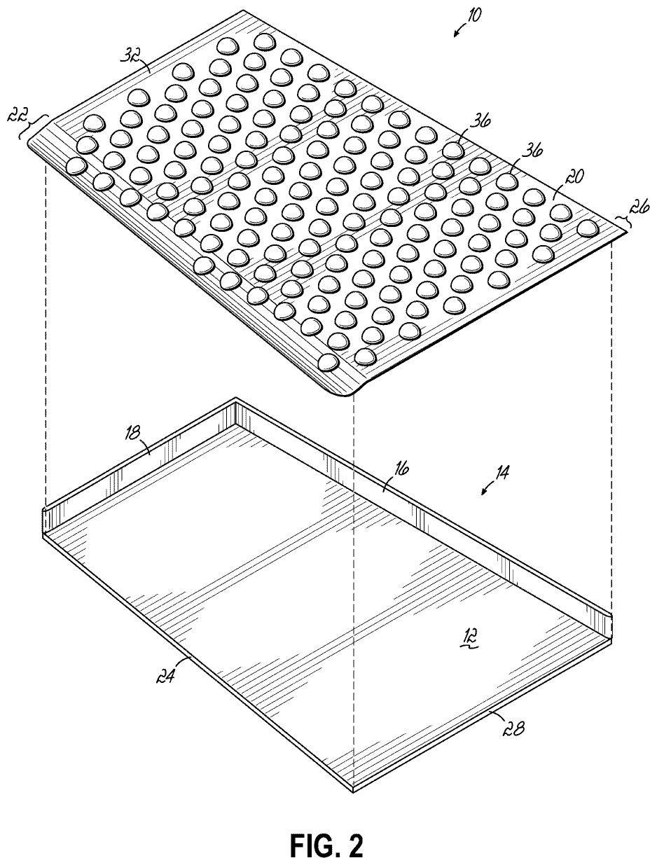

A schematic representation of a material handling system 4 is shown in FIG. 1. The material handling system 4 includes a conveyor assembly 6, tilt tray assemblies 7, and deposit chutes 8. The tilt tray assemblies 7 in a liner 10 placed onto a carrier plate 12 (FIG. 2) of a tilt tray 14. The liner 10 according to one embodiment of the disclosure is shown in more detail in FIGS. 2-4. The conveyor assembly 6 is moving from left to right as depicted by the arrows. Each tilt tray 14 is adapted to receive, carry, and unload one or more packages 15, such as a lightweight poly bag, for example, as part of conveyor assembly 6 of the material handling system 4. With reference to FIG. 2, the tilt tray 14 includes a first side wall 16 and a second side wall 18, which collectively assist with keeping the package 15 in the tilt tray 14 during transport via the conveyor assembly 6 of the material handling system 4. As shown in FIG. 2, the first side wall 16 extends from one edge of the carrier plate 12 and the second side wall 18 extends from another edge of the carrier plate 12.

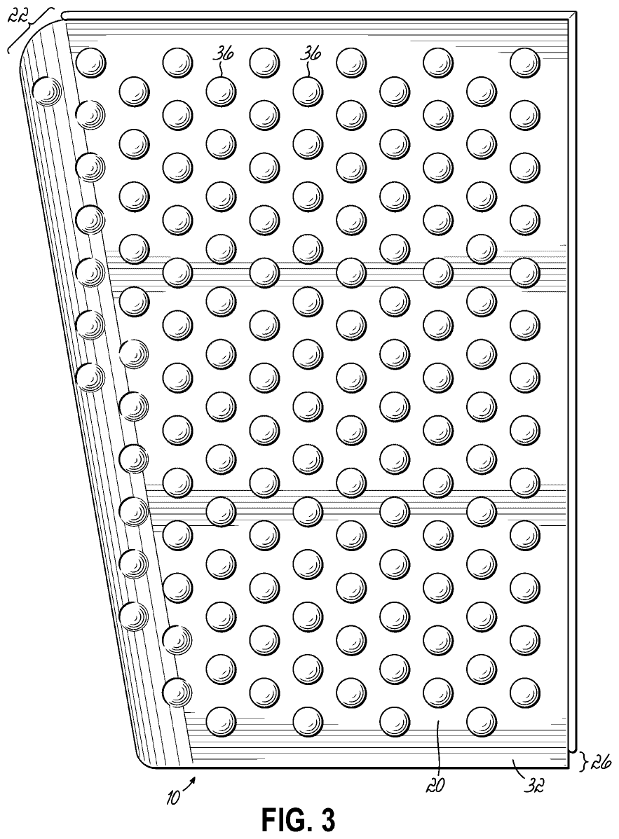

With reference to FIG. 3, the liner 10 has a support panel 20 which is shown positioned on the carrier plate 12 of the tilt tray 14. In an embodiment, the liner 10 may include a first edge portion 22 that extends over a first edge 24 (FIG. 2) of the carrier plate 12. That first edge portion 22 may also angle downwardly over that first edge 24 of the carrier plate 12. In an embodiment, the liner 10 may include a second edge portion 26 that extends over a second edge 30 of the carrier plate 12. In an embodiment the carrier plate 12 has a perimeter that defines a planform shape of the carrier plate 12. Similarly, the support panel 20 has a perimeter that defines a planform shape of the support panel 20. In an embodiment, the planform shape of the support panel 20 substantially corresponds to the planform shape of the carrier plate 12. Consequently, when the support panel 20 is positioned over the carrier plate 12, the support panel 20 will cover essentially all of the carrier plate 12 as depicted in FIG. 3 and one edge of the support panel 20 is positioned adjacent to the first side wall 16 of the carrier plate 12 and another edge of the support panel 20 is positioned adjacent to the second side wall 18 of the carrier plate 12.

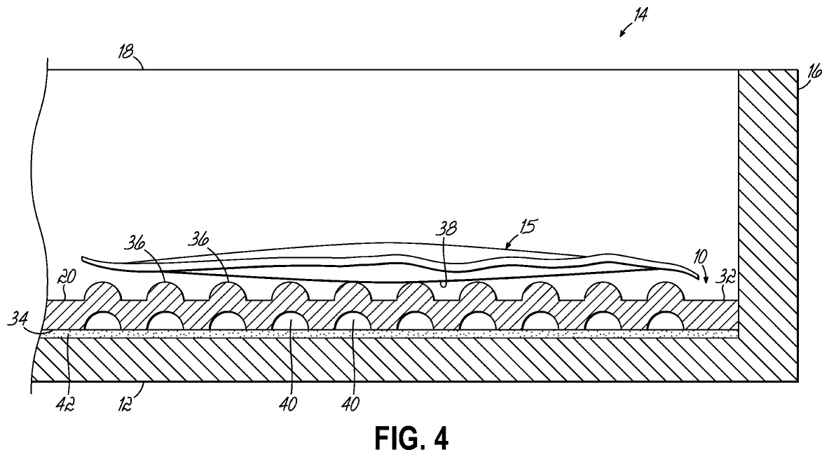

FIG. 4 is a schematic cross-sectional view of the tilt tray 14 with the liner 10 and the package 15 resting upon the liner 10. Some components in FIG. 4 are spaced apart to clarify the presentation. The support panel 20 of liner 10 includes a top surface 32 and a bottom surface 34 and a plurality of raised portions 36 arranged in an array over the top surface 32. The raised portions 36 are configured to support the package 15 and minimize contact between a bottom 38 of the package 15 and the top surface 32 of the support panel 20. The raised portions 36 are shown having an arcuate profile, but other profiles are possible, such as a square, rectangular, pyramidal, trapezoidal, conical, cylindrical, and the like. The array (i.e., arrangement and spacing) of the raised portions 36 over the top surface 32 may be of any general configuration so long as the array minimizes the contact between the bottom 38 of the package 15 and the top surface 32. In an embodiment, the raised portions 36 may be created by pressing a tool onto the bottom surface 34 so as to press a dimple 40 in the bottom surface 34 and simultaneously creating corresponding raised portions 36 on the top surface 32. In an embodiment, the array of raised portions 36 extends across more than half of the top surface 32 of the support panel 20.

In an embodiment, the liner 10 may be initially created in a sheet-like form with the raised portions 36 in the support panel 20. The initial form of the liner 10 may be of any size and geometry. After the liner 10 is initially formed, the liner 10 may be cut or trimmed to generally correspond to the size and geometry of the carrier plate 12 of the tilt tray 14. When the size and geometry of the tilt tray 14 is generally the same for most or all of the tilt trays 14, the liner 10 with raised portions 36 may be formed in a mold or a stamping process or another appropriate method such that the finished liner 10 readily fits into the tilt tray 14 without the need for any additional trimming of the liner 10. After the liner 10 is sized and shaped to correspond to the size and shape of the tilt tray 14, the bottom surface 34 of the liner 10 may be secured to the tilt tray 14 with any suitable adhesive 42 as shown in FIG. 4. The adhesive 42 may be applied to either the bottom surface 34 of the liner 10 or the carrier plate 12 of the tilt tray 14 or both before the liner 10 is secured to the carrier plate 12 of the tilt tray 14. Other means may also be used to secure the liner 10 to the tilt tray 14 besides the adhesive 42 such as by mechanical fasteners, e.g., rivets, nuts and bolts, staples, etc.

Because the package 15 may a very lightweight poly bag, static friction may prevent the poly bag from sliding out of the tilt tray 14 when the tilt tray 14 is tilted to dump the poly bag at the location corresponding to final destination of the poly bag. To mitigate the effects of static friction, the liner 10 may be made from a silicone-infused ultra-high molecular weight (UHMW) material. A silicone-infused UHMW material has an extremely low coefficient of friction as well as being resistant to forming static friction, i.e., it is anti-static. When the liner 10 (e.g., the support panel 20 and the raised portion 36) is made from the silicone-infused UHMW, even extremely lightweight poly bags will slide out of the tilt tray 14 when the tilt tray 14 is tilted up.

The tilt tray 14 is shown with first and second side walls 16, 18 oriented perpendicular to each other. In an embodiment, the tilt tray 14 may also have side walls that are opposing edges of the tilt tray 14. In an embodiment, the tilt tray 14 may have three sidewalls forming a U-shaped perimeter around three edges of the tilt tray 14. In an embodiment, the tilt tray 14 may have no side walls. As noted above, the carrier plate 12 of the tilt tray 14 includes a perimeter defining a planform shape of the carrier plate 12. The planform shape of the carrier plate 12 shown in the figures has a generally trapezoidal shape. Consequently, the liner 10 has a corresponding trapezoidal shape to generally match the trapezoidal shape of the carrier plate 12 of the tilt tray 14. In an embodiment, the carrier plate 12 of the tilt tray 14 may have another shape such as a quadrilateral, which may include a rectangle, square, rhombus, parallelogram, deltoid, and kite, for example. Whatever the shape the carrier plate 12, the liner 10 should be shaped to generally match the shape of the carrier plate 12, so that the package 15 is supported primarily by the raised portions 36.

The disclosure also contemplates a method of moving a package 15 to a designated location on a conveyor assembly 6 on a material handling system 4. The method includes providing a material handling system 4 having a conveyor assembly 6. The conveyor assembly 6 includes one or more tilt trays 14. The tilt tray 14 has the carrier plate 12 with the perimeter defining the planform shape of the carrier plate 12. The method includes securing the liner 10 to the carrier plate 12. In an embodiment, the liner 10 may be secured to the carrier plate 12 with the adhesive 42 or any other suitable fastener. The method may further include placing the package 15 onto the liner 10 and operating the conveyor to move the package 15 from a first location to a second location. The method may further include tilting the tilt tray 14 so as to cause the package 15 to slide off of the liner 10 at a designated location along the material handling system 4.

While the present disclosure has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The present disclosure in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A liner for a tilt tray of a conveyor assembly on a material handling system, where the tilt tray as a carrier plate with a perimeter defining a planform shape of the carrier plate, the liner comprising:
a support panel with a perimeter defining a planform shape of the support panel, wherein the planform shape of the support panel is configured to substantially correspond to the planform shape of the carrier plate of the tilt tray, the support panel having a top surface and a bottom surface and an array of raised portions extending from the top surface,
wherein the support panel is made of a material that is resistant to static friction.

2. The liner of claim 1, wherein the support panel is made of a silicone-infused, ultra-high molecular weight (UHMW) material.

3. The liner of claim 1, wherein the array of the raised portions extends across more than half of the top surface of the support panel.

4. The liner of claim 1, wherein the support panel includes a first edge portion configured to extend over a first edge of the carrier plate.

5. The liner of claim 4, wherein the first edge portion is configured to angle downwardly over the first edge of the carrier plate.

6. The liner of claim 4, where the support panel includes a second edge portion configured to extend over second edge of the carrier plate.

7. A tilt tray assembly for use on a conveyor assembly on a material handling system comprising:
a tilt tray having a carrier plate with a perimeter defining a planform shape of the carrier plate; and
a liner having a support panel with a perimeter defining a planform shape of the panel, wherein the planform shape of the support panel is configured to substantially correspond to the planform shape of the carrier plate of the tilt tray, the support panel having a top surface and a bottom surface and an array of raised portions extending from the top surface, the bottom surface of the support panel being secured to the carrier plate of the tilt tray,
wherein the support panel is made of a material that is resistant to static friction.

8. The tilt tray assembly of claim 7, wherein the support panel is made of a silicone-infused, ultra-high molecular weight (UHMW) material.

9. The tilt tray assembly of claim 7, wherein the array of the raised portions extends across more than half of the top surface of the support panel.

10. The tilt tray assembly of claim 7, wherein the support panel includes a first edge portion configured to extend over a first edge of the carrier plate.

11. The tilt tray assembly of claim 10, wherein the first edge portion is configured to angle downwardly over the first edge of the carrier plate.

12. The tilt tray assembly of claim 10, wherein the support panel includes a second edge portion configured to extend over a second edge of the carrier plate.

13. The tilt tray assembly of claim 7, wherein the support panel is secured to the carrier plate of the tilt tray.

14. The tilt tray assembly of claim 13, wherein the support panel is secured to the carrier plate of the tilt tray with an adhesive.

15. The tilt tray assembly of claim 7, wherein the tilt tray includes at least one sidewall extending from an edge of the carrier plate and an edge of the support panel of the liner is positioned adjacent to the at least one sidewall.

16. A method of moving a package to a designated location on a conveyor assembly on a material handling system comprising:
providing a tilt tray assembly on the conveyor assembly, the tilt tray assembly having a tilt tray having a carrier plate and a liner secured to the carrier plate, the liner having a support panel with an array of raised portions extending from a top surface of the support panel, the support panel being made from a material that is resistant to static friction;
placing the package on the liner;
moving the tilt tray assembly to the designated location; and
tilting the tilt tray sufficiently so that the package slides off the liner.

17. The method of claim 16, wherein the support panel is made of a silicone-infused, ultra-high molecular weight (UHMW) material.

18. The method of claim 16, wherein the array of the raised portions extends across more than half of the top surface of the support panel.

19. The method of claim 16, wherein the support panel is secured to the carrier plate of the tilt tray with an adhesive.

20. The method of claim 16, wherein the tilt tray includes at least one sidewall extending from an edge of the carrier plate and an edge of the support panel of the liner is positioned adjacent to the at least one sidewall.
